(19) United States
(12) Patent Application Publication
(10) Pub. No.: US 2020/0206872 A1
(43) Pub. Date: Jul. 2, 2020

(54) HANDHELD SANDBLASTING DUST COLLECTOR

(71) Applicant: Boaz Barry Groman, Boca Raton, FL (US)

(72) Inventor: Boaz Barry Groman, Boca Raton, FL (US)

(21) Appl. No.: 16/724,411

(22) Filed: Dec. 23, 2019

Related U.S. Application Data
(60) Provisional application No. 62/784,853, filed on Dec. 26, 2018.

(51) Int. Cl. B24C 9/00; B65D 33/25; B65D 33/01; B24C 3/18

(52) U.S. Cl. CPC B24C 9/00; B65D 33/2591; A61C 3/025; B24C 3/18; B65D 33/01

(57) ABSTRACT

Handheld dust collector (or disposable dust cabinet) for sandblasting small objects, such as extraoral sandblasting of dental devices. The apparatus may comprise a bag with an open, resealable end. An access panel on the bag allows a user to insert their fingers into the bag, such as with integrated finger cots. A filter may be provided to allow air to escape from the bag. Methods of treatment are disclosed.

### CROSS-REFERENCE TO RELATED APPLICATION(S)

This is a nonprovisional of 62/784,853 filed 26 Dec. 2018, incorporated by reference herein, and claiming filing date benefit thereof.

### TECHNICAL FIELD

This disclosure relates to sandblasting apparatus, more particularly to handheld disposable apparatus that may be used to perform surface treatment on small objects such as dental devices (false teeth, etc.), and to techniques for performing the treatments.

### BACKGROUND

Extraoral (outside of the mouth, rather than inside the mouth) sandblasting (abrasive surface treatment) procedures on dental devices, such as crowns, ortho (orthodontic) brackets, dentures, etc. are currently typically performed in a sandblasting cabinet at a dental lab (laboratory) room.

U.S. Pat. No. 4,475,370 (1984 Oct. 9, Stark) discloses a device for treating dental castings. An apparatus for treating the surface of a dental inlay for a tooth has a cup enclosure with a restricted opening therein. A hollow stem is slidably received in the cup and releasably held in a chosen position. An inlay holder is at the end of the stem within the cup enclosure and in the path of a stream of grit particles projected from the reservoir through a nozzle extending through the opening into proximity with the inlay holder.

U.S. Pat. No. 6,024,566 (2000 Feb. 15, Bruns) discloses an abrasive container for gas-abrasive applications. A device for containing abrasive particles expelled from air-abrasive apparatus and permitting their facile removal without the aid of a vacuum source, while facilitating a relatively unobstructed view of the working area during use. One embodiment disclosed is a device for containing abrasive material expelled by a gas abrasive dental apparatus. The device comprises a flexible puncturable, substantially flat distal sheet comprising one side of the device for isolating a tooth surface to be abraded; a transparent, puncturable, substantially flat proximal sheet comprising the other side of the device; an enclosure for containing the abrasive material. The enclosure is formed by the junction of the proximal sheet and the distal sheet; an enclosure sealing means for permitting access to the enclosure and sealing the enclosure, a filtering means integrated with at least one sheet for permitting the passage of a gas while entrapping the abrasive material, and a rubber dam integrated with the distal sheet, which rubber dam can be secured from within the enclosure around the tooth surface to be abraded by a clamping member. Certain other embodiments of the device can be used for non-dental applications.

US 2006/0252006 (2006 Nov. 9, Apelker and Groman) discloses a process for capture and removal of abrasive material for gas abrasive applications. A device for capturing abrasive particles expelled from air-abrasive apparatus and permitting their facile removal without the aid of a vacuum source, while facilitating an unobstructed view of the working area during use. One embodiment disclosed is a capture and removal device (1) of abrasive material (70) expelled by a gas abrasive dental apparatus (25) by generating a water curtain (50) from a water steam (45) delivered substantially tangential to concave surface (20) of a curved sheet (10). A method is disclosed for using water curtain (50) generated by capture and removal device (1) to capture and remove abrasive material (70) from the vicinity of an air-abrasive procedure. Certain other embodiments of the device can be used for non-dental applications.

U.S. Pat. No. 7,607,972 (27 Oct. 2009; Groman) discloses a self-contained disposable micro-abrasive blasting tip for dental applications, which may be used in conjunction with the present invention.

### SUMMARY

It is an object of the invention disclosed herein, in its various embodiments, to provide an inexpensive, handheld dust collector apparatus (or “mini-cabinet”) for use in conjunction with extraoral sandblasting of dental devices. The dust collector may be used for surface treatment of other small objects, such as jewelry, etc.

Various embodiments of dental dust collector apparatus is disclosed for allowing a user to grasp (hold, and easily reposition) a dental device (or other object being treated) while it is being sand-blasted (for example). Methods of use are also disclosed.

According to the invention, generally, a handheld dust collector (or disposable dust cabinet) is provided for sandblasting small objects, such as for performing extraoral sandblasting of dental devices. The apparatus may comprise a bag with an open, resealable end. An access panel on the bag allows a user to insert their fingers into the bag, such as with integrated finger cots, while maintaining air-tightness so that the bag may inflate when a micro-abrasive blasting tip for dental applications is inserted into the bag, and a pressurized air stream is flowing into the bag. A filter may be provided to allow air to escape from the bag. Methods of treatment are disclosed.

According to some embodiments or examples of the invention, a disposable dust cabinet apparatus for sandblasting small items may comprise: a bag having a front panel and a back panel, wherein one end of the bag is open and has means for selectively sealing and opening the bag; an access panel disposed on a one of the front and rear panels; at least one finger cutout extending through the access panel for allowing a user to insert corresponding at least one of their fingers into the bag, through the access panel. There may be two finger cutouts extending through the access panel for allowing a user to insert corresponding two of their fingers into the bag, through the access panel.

The material of the access panel, outside of the finger cutout(s), may be segmented to have a number of segments.

There may be at least one finger cot extending from the corresponding at least one finger cutout in the access panel to within an interior of the bag.

The front and back panels may be generally rectangular in shape, and substantially the same size as one another. The access panel may be formed of a flexible semi-rigid material selected from the group consisting of card stock and plastic.

The means for selectively sealing and opening the bag may comprise: one or more rows of grooves provided along an edge of one of the front and back panels, and one or more rows of ridges provided along an edge of another of the front and back panels, and a slider for selectively engaging the ridges into the grooves, thereby sealing the bag, and disengaging the ridges from the grooves, thereby opening the bag.

An air filter may be disposed on one of the front and back panels of the bag. The air filter may be disposed on the access panel.

The access panel may comprise a designated area of the bag which is stiffer than the front and back panels of the bag. The access panel may comprise a stiff panel such as card stock or plastic which is joined to a front or back panel of the bag covering a cutout portion of the bag.

According to some embodiments or examples of the invention, a system for performing micro-abrasive blasting for dental applications may comprise: a disposable dust cabinet apparatus as described herein, and a micro-abrasive blasting tip for performing dental applications. The micro-abrasive blasting tip for dental applications may be a micro-abrasive blasting tip such as is disclosed in U.S. Pat. No. 7,607,972.

According to some embodiments or examples of the invention, a method of sandblasting a small object may comprise: providing a disposable dust cabinet apparatus as described herein; with one hand, inserting two fingers into corresponding two finger cots; with the other hand, placing the small object into the bag, via the open end of the bag; with the two fingers of the one hand, grasping the object to be sandblasted; with the other hand, closing the open end of the bag; introducing a nozzle of a sandblasting apparatus into the bag; and performing the sand blasting. While performing the sandblasting, both the sandblasting apparatus and the object being sandblasted may be manipulated by the user.

At the conclusion of sandblasting, the nozzle of the sandblasting apparatus may be withdrawn from the bag, the bag may be opened, the object may be retrieved from the bag, and the user may withdraw their fingers from the finger cots.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be exaggerated, others may be omitted, for illustrative clarity. Some figures may be in the form of diagrams.

Although the invention may be described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

FIG. 1 is a perspective view of a cup-type dust collector, according to an embodiment of the invention.

FIG. 2 is a perspective view of another cup-type dust collector, according to an embodiment of the invention.

FIG. 3 is a perspective view of a disposable dust cabinet, according to an embodiment of the invention.

FIG. 3A is a detailed view of a portion of the access panel 120, and an exemplary finger opening 130 disposed in the access panel.

FIG. 4 is a cross-sectional view of a portion of the disposable dust cabinet of FIG. 3.

FIG. 4A is partial cross-sectional view of the access panel 120, with a filter 140 disposed on its external surface.

FIG. 4B is partial cross-sectional view of the access panel 120, with a filter 140 disposed on its internal surface.

### DETAILED DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein. Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

### An Embodiment

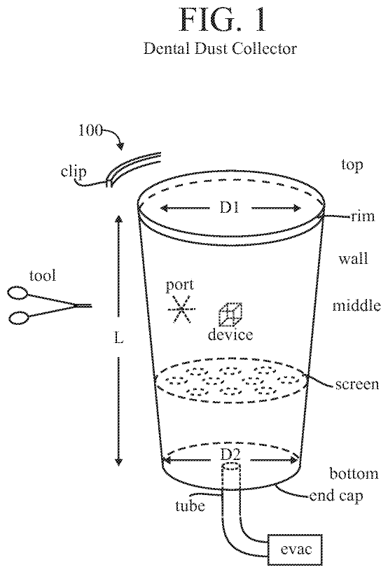

FIG. 1 shows a first embodiment 100. In this embodiment, sand (or powder, or other abrasive material) and detritus (material removed from the dental device during surface treatment) is collected with a dental evacuation (“evac”) or other comparable suction system.

As used herein, “detritus” includes any waste material resulting from sandblasting a small object such as a dental device, including both overspray and particles removed from the dental device.

The dust collectors disclosed herein may be disposable, in the sense that they are made of inexpensive materials, and easy to manufacture.

The overall dust collector 100 may be generally cone-shaped, like a funnel, having a large opening at one end, and a smaller opening at the other end.

The dental dust collector may be mounted mounts to a dental evac (evacuation) adapter, or to suction tubing, both of which are typically available at a dental chair.

The main body of the dust collector may be a rigid, or semi-rigid, or flexible wall structure, and it may have indentations for indicating to a user where to grasp the apparatus in such a manner as to be able to hold and manipulate (such as re-position or re-orient) a dental device disposed within the dust collector.

A rigid wall structure may be soft (flexible) at specific locations to facilitate the user grasping of the dental device while maintaining an integral wall structure which optimizes suction, direction of air flow, and eliminate voids for optimal powder containment, and to permit grasping and manipulation (and repositioning) of the dental device surface with respect to the sand blasting nozzle.

A mesh or screen type structure disposed in the dust collector to permit suction collection of detritus (powder and removed material), while capturing the dental device when released.

For repositioning the dental device, it may be released, captured on the screen, and easily recaptured (retrieved) by the user, for repositioning.

The dust collector is comparable to a cabinet, in that it defines a semi-closed space for performing a treatment such as sandblasting.

More specifically,

The dental dust collector may comprise:
a body member comprising a cylindrical, or frustro-conical (funnel shaped) wall having two opposite ends (top and bottom), wherein:
   a first (top) of the two ends has a first diameter (D1) and is open
   a second (bottom) of the two ends has a second diameter (D2) which may be less than or equal to the first diameter.
   the first diameter (D1) of the body member may be approximately 4-6 inches
   the second diameter (D2) of the body member may be approximately 2-3 inches
   a height (L, or axial length) of the body member may be approximately 4-10 inches
   at least a portion of the body member (wall) may be formed of a semi-rigid (deformable, flexible) such as PVC, PET or other polycarbonate material, having a thickness of approximately 10-40 thousandths of an inch.
a middle portion of the body member (wall) may be disposed approximately midway between the two (top and bottom) ends of the body member, wherein:
   the middle portion of the body member (wall) may be contoured inwardly, such as on diametrically opposed portions of the wall, to facilitate a user grasping the dust collector approximately midway along its length with one hand, while allowing access to the open top end with the other hand.
   the middle portion of the body member (wall) may be flexible to allow the user to deform the wall inwardly to hold/manipulate/reposition a dental device within the body member, for performing a procedure such as sand-blasting the dental device

The bottom end of the body member may be closed off (with an end cap), and provided with a fitting for connecting to an evac adapter or suction tubing to create a downward airflow through the body member for evacuating excess treatment material such as sand (powder) overspray, as well as material which has been removed from the dental device being treated.

A mesh or screen may be disposed below (towards bottom end) the middle portion, for preventing the dental device from being sucked out of the dust collector during treatment of the dental device. The mesh should have openings smaller than the object receiving surface treatment—for example, but not limited to a ⅛″ mesh.

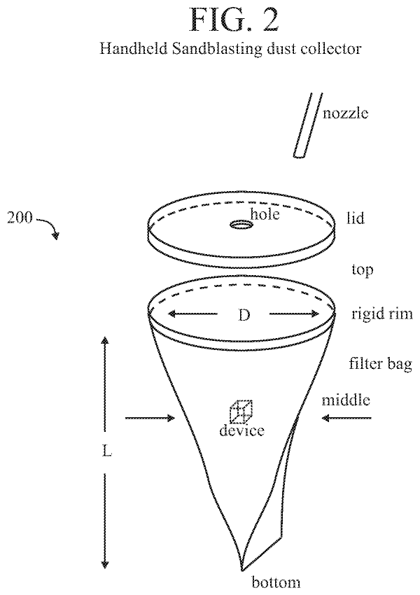

Optionally, a lid (not shown, see FIG. 2 embodiment) for closing off the top may be provided to capture any particles which may bounce off the device during operation and may not be captured by the air flow, preventing escape through the (otherwise open) top. The lid should have an opening for inserting the micro-abrasive blasting tip (or nozzle).

The body member may comprise, from top down, (i) an upper portion, disposed between the top end and the middle portion, which may be funnel-shaped (tapered), followed by (ii) the middle portion which may be indented for a user's fingers and which may be flexible so that the user can grasp a dental device with the middle portion, and (iii) a lower portion, disposed between the middle portion and the bottom end (and having a fitting at the bottom end), which may be funnel-shaped (tapered).

The upper portion of the body member (wall) may be more rigid (such as thicker, less flexible, or ribbed) than the middle portion.

The lower portion of the body member (wall) may be more rigid (such as thicker, less flexible, or ribbed) than the middle portion.

The middle portion of the body member (wall) may be less rigid (such as thinner, more flexible) than the middle portion.

Sometimes the dental device may be small, or difficult to hold, in which an access port may be provided in the side of the body member for holding the device with a clamping tool such as an alligator clip or a hemostat. The access port may comprise a hole, or opening, or simply some intersecting slits, allowing the tool with device to be inserted through the side of the body member into the treatment area.

The entire body portion may be flexible, such as of a textile material in which case rigid (reinforcing) pieces (trim, segments, strips, clips) may be disposed about the top end (rim) to maintain the top end in a substantially circular configuration. For example, four reinforcing strips, may be disposed on the top edge of the wall at the open end of the dust collector. Each of the four strips may extend approximately 80° about the circumference of the rim, and the strips may be evenly distributed (spaced) about the rim. This will help keep the open end of a flexible dust collector open.

An end cap may be provided at the bottom end of the body member, with a tube (or fitting, or spigot) extending therefrom for connecting with an evac system. The spigot may be integral with the end cap, and both may be made of plastic.

In use, the user may . . .
connect the evac system or vacuum tubing to the spigot at the bottom end of the dust collector
hold the dust collector between the thumb and a finger (such as the index/fore finger, or middle finger, or both)
position and grasp the dental device within the dust collector, such as by applying pressure to the middle portion to deform the middle portion sufficiently to grasp the dental device
with another hand, position a sand-blasting device, such as disclosed in U.S. Pat. No. 7,607,972, in proximity with the dental device so as to treat (e.g., sand blast) the dental device
reposition the dental device, as desired. This may include releasing the dental device, and grasping it again.
cease treating the dental device, such as by turning off the evac system,
release and retrieve the dental device from the dust collector
disconnecting the dust collector from the evac system
dispose of the dust collector

### Another Embodiment

The first embodiment 100, described above, uses chair-side vacuum (evac) to collect particulate matter (sand and detritus), and therefore requires access to an evacuation hose.

FIG. 2 shows another embodiment of a Handheld Sandblasting dust collector 200. This embodiment is “stand-alone” in that it does not require an evacuation system.

In this embodiment, a filter bag is mounted to a rigid rim (hoop structure).

The rim may comprise a rigid piece of plastic. The rim may be circular (a hoop structure), and may measure approximately 2-3 inches in diameter (D), having a circumference of approximately 6-10 inches.

The bag may comprise a porous textile material, selected to allow air to pass easily therethrough while trapping sand (or powder) and detritus (material removed from the dental device) within the bag, much like the bag of a vacuum cleaner. In this regard, the bag may be considered to be a “filter bag”. The bag is open at its top end (where it attaches to the rim), and is closed at its bottom end.

The bag may be cylindrical, or conical, or wedge-shaped, or a combination of those shapes. For example, a top portion of the bag (such as approximately 50% of the length of the bag) may be cylindrical, and the bottom portion (or remaining 50% of the length of the bag) may be wedge-shaped.

The bag may be flexible, to allow a user to easily grasp and manipulate a dental device disposed within the bag.

The bag may measure approximately 4-5 inches in depth (length, L), and the opening at its top end corresponds in size to the rim, which has a diameter (or perimeter) of 6-10 inches.

A lid is provided that snaps to the top of the rim (hence, to the top of the bag, with the dental device contained therein). The lid makes a tight seal with the rim. The lid may comprise a plastic disc with hole in it to allow a nozzle of a micro-abrasive sandblasting tip to be inserted through the hole in the lid to treat a dental device held within the bag. An example of a micro-abrasive blasting tip is presented in U.S. Pat. No. 7,607,972, the relevant portion of which is the needle-like delivery conduit (30). The lid may be comparable to the lid on a drink cup, having a hole for a straw.

The rim may be detachable from the filter bag, and may be segmented, as in the embodiment 100 of FIG. 1. In this manner, filter bags may be disposed of, new ones used for each treatment of a dental device.

The dust collector 200 may comprise:
a bag having an open end and a closed end:
a rim attached around the open end of the bag;
a lid capable of being disposed on the open end (rim) of the bag;
a hole extending through the lid, such as at the center thereof.

In use, the user may
hold the bag in one hand, rim (top) side up.
with the other hand, place the dental device to be treated within the bag, grasping it with his/her fingers (such as between the thumb and index finger), presenting a surface of the device to be treated towards the top of the bag
places the lid on the top of the bag (rim), and snaps it in place
inserts the nozzle of the sandblaster through the hole in the lid
performs surface-treatment (sandblasting) on the dental device
manipulates and repositions the dental device, which may include stopping, removing the lid, repositioning the dental device, reinstalling the lid, and re-inserting the nozzle
ceases sandblasting
remove the nozzle from the lid
remove the lid from the bag
remove the dental device from the bag
dump the remaining sand/detritus from the bag, or dispose of the bag with sand/detritus in it.

There has thus been described some embodiments of an inexpensive, handheld dust collector apparatus for use in conjunction with surface treatment (such as extraoral sandblasting) of small objects (such as dental devices, jewelry, etc.) comprising:
a container comprising a generally cylindrical, or conical, or wedge-shaped wall which is open at a top end of the container for allowing a dental device to be inserted, then treated with a nozzle (such as a micro-abrasive sandblasting tip), a bottom end of the container being closed; and
further comprising one or more of the following features:
the wall is rigid, or semi-rigid, or flexible and,
   if the wall is rigid, it may be soft (flexible) at specific locations to allow grasping and manipulating the dental device; and
   if the wall is flexible (such as of a textile material), rigid (reinforcing) pieces (trim, segments, strips, clips) may be disposed about the top end (rim) to maintain the top end in a substantially circular configuration;
a mesh disposed in a middle portion of the container for preventing the dental device from being sucked out of the dust collector during treatment of the dental device;
the bottom end of the body member may be closed off (with an end cap) and provided with a fitting for connecting to apparatus for creating a downward airflow through the container for evacuating excess treatment material such as sand (powder) overspray, as well as material which has been removed from the dental device being treated;
an access port (comprising a hole, or opening, or simply some intersecting slits) disposed in the wall for allowing a clamping tool with device clamped therein to be inserted through the wall into a treatment area within the device;
the wall comprises a filter bag, closed at the bottom end, and having a rigid rim (hoop structure) at its top end; and
a lid for closing off the top end, said lid having an opening for inserting the micro-abrasive sandblasting tip.

### DispoCab™

### Disposable Dust Cabinet

There will now be described a “new and improved” version of a sandblasting cabinet (or dust collector apparatus, and method). Some of the same principles described hereinabove may be applicable to this “new” embodiment, such as its intended use, as well as being inexpensive, disposable, and intended for single use.

Ziplock (or Ziploc™) bags are well-known, and generally comprise two generally rectangular plastic panels—a front panel and a rear panel—joined along three edges thereof (left, right, bottom), and open at a “top” edge thereof.

One or more rows of grooves may be provided on (along) the top edge of one panel, and one or more rows of ridges may be provided on (along) the top edge of the other panel. Together, these ridges and grooves may comprise means for selectively sealing and opening the bag. The combination of ridges and grooves may be referred to as a “zipper”.

In use, a user may grasp the top edge of the bag, such as with thumb and forefinger, causing the ridges to insert (and interlock) into the grooves, then sliding the clinched thumb/forefinger across the top edge of the bag to seal the opening. To unseal (open) the bag, the user may grasp the two top edges of the two panels and pull them apart.

Some ziplock bags come with a “slider” or “tang” which forces (manipulates, engages) the ridges into the grooves. In use, a user may grasp the slider, then slide the slider along the top edge of the bag, in one direction, to seal the opening (i.e., to seal the bag). To unseal (open) the bag, the user may grasp the slider and slide it in the opposite direction, thereby disengaging the ridges from the grooves and unsealing the bag.

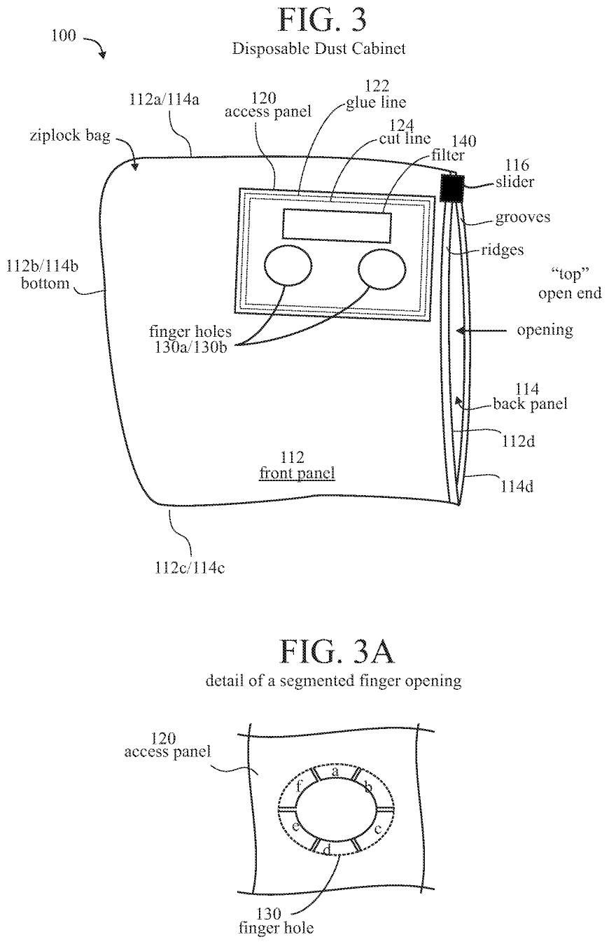

FIG. 3 shows, in a perspective view, a disposable dust “cabinet” 100, according to an embodiment of the invention. The cabinet 100 comprises a bag 110 and an access panel 120, both of which are described in greater detail hereinbelow.

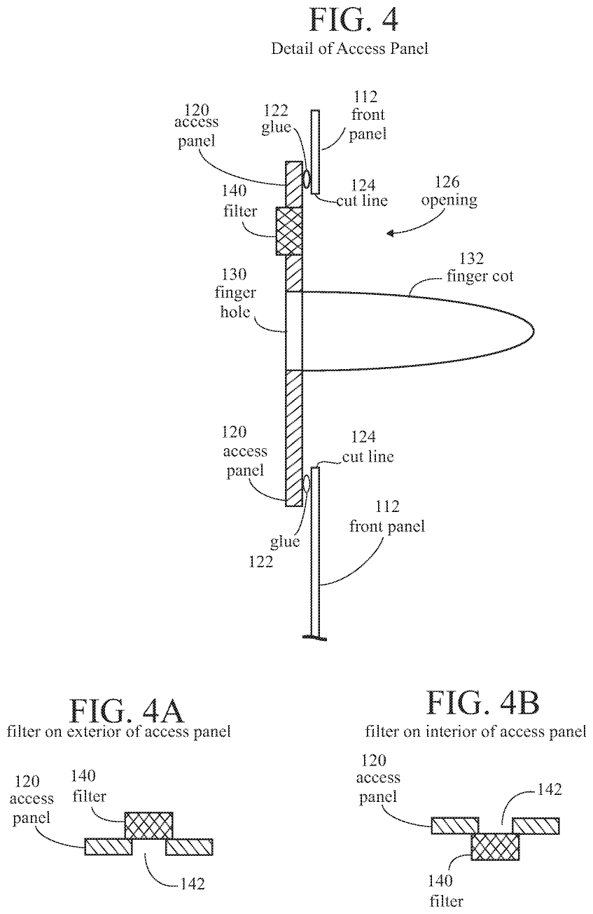

FIG. 4 shows, in a partial side cross-sectional view, the construction of the access panel 120 in greater detail.

The bag 110 may be a ziplock bag, such as has been described hereinabove, comprising a generally rectangular front panel 112, and a generally rectangular back panel 114. The front and back panels may be substantially the same size as one another, and may be formed of a plastic film material, such as a few (5-15) thousandths of an inch thick, or 0.15-0.4 mm thick. Typically, the plastic material is see-through.

As best viewed in FIG. 3, each of the front and back panels have four sides (or edges). Three of these sides may be permanently joined together (or integral) with one another. As viewed in the figure, these are the top 112a/114a, left 112b/114b and bottom 112c/114c edges of the front and back panels 112/114, respectively.

A fourth side (or edge) 112d/114d of the front and back panels 112/114 are not joined together with one another. Rather, this side, or what we may refer to as the “top” end of the bag, is left open for inserting and withdrawing objects from the bag.

More particularly, the top edges 112d and 114d of the front and back panels are provided with ridges and grooves, respectively, as described hereinabove, which may be forced together to interlock with one another to seal contents within the bag, and which may be separated from one another to allow objects to later be withdrawn from the bag.

A slider 116 may be provided which the user may grasp and slide along the top edges of the front/back panels in one direction (downward, as viewed in the figure) to interlock the ridges and grooves, thereby sealing the bag. And, conversely, the user may grasp and slide the slider in the opposite direction (e.g., upward, as viewed in the figure) to unseal the bag.

Thus far, what has been described is essentially a conventional ziplock bag as an example of an enclosure which may be modified for use as a disposable “cabinet” for dental sandblasting.

An access panel 120 has been mentioned above, and will now be described in greater detail, with reference to both of FIGS. 3 and 4.

The access panel 120 may comprise a preferably flat, somewhat flexible (semi-rigid) panel of material, such as cardboard or plastic. For example, 40 thousandths (1 mm) thick card stock. The access panel 120 may be noticeably less flexible (more rigid) than the front and back panels 112 and 114.

The access panel 120 may be rectangular, and may be smaller than the front/back panels of the bag. For example, the front/back panels of the bag may measure 5 inches×7 inches (12.5 cm×17.5 cm), and the access panel may measure 3 inches×5 inches (7.5 cm×12.5 cm).

The access panel 120 may be positioned, as best viewed in FIG. 3, towards a top right corner of the bag. More particularly, the access panel 120 may be disposed on the front panel 112, very close to the ridges and the slider 116. This will facilitate the user manipulating the slider with their fingers inserted in the access panel, as described hereinbelow. The access panel may be disposed close to the bag's zipper (ridges and grooves) so that the zipper is supported when manipulating the slider (e.g., with the user's fingers inserted into the access panel).

In use, the bag may be positioned so that when the ziplock is open, the slider is adjacent the upper edge (as viewed) of the access panel.

The access panel 120 may be glued to the front panel 112 of the bag with a suitable adhesive 122 (FIG. 4) around its periphery. And the front panel of the bag may be cut, along a cut line 124 so that there is a large opening 126 (defined by the cut line) in the front panel of the bag, wherein said opening is smaller in dimension than the access panel, so that when the access panel 120 is glued to the front panel 112, the bag may remain sealed (e.g., airtight, water tight). For example, the opening 126 in the front panel may measure 2 inches×4 inches (5 cm×10 cm).

The access panel 120 may be provided with two finger cutouts (or holes) 130a and 130b (collectively and individually referred to as “130”) for allowing a user to insert two of their fingers (such as thumb and forefinger) into the bag, through the access panel on the front panel thereof.

Alternatively, there may be only one “finger cutout” or access hole allowing a user to insert a tool (such as tweezers) into the bag, as described hereinbelow.

The two finger cutouts (or holes) may be sized so that fingers can access them, and may be spaced apart a suitable distance so that the access panel (e.g., cardboard) is comfortably rested and supported by both fingers.

To maintain the airtight integrity of the bag, these two finger cutouts (or holes) may be provided with any suitable sealing mechanism such as some overlapping flexible flaps.

Or, the finger cutouts may be suitably sized, such as slightly undersized (i.e., on the “small side” of things), yet flexible (yielding), so that the user's fingers (preferably wearing gloves) seal themselves against the edges of the cutouts in the access panel.

FIG. 3A is a detailed view of a portion of the access panel 120, and an exemplary finger opening 130 disposed in the access panel. The finger opening may be round, or slightly oval. An outside dimension of the finger hole is shown as a dashed line, and should be sized to accommodate a large finger. An inside dimension of the finger hole is shown as a solid line, and is sized to be smaller than the outside dimension. The material between the outside dimension and the inside dimension (or, the material which surrounds the inside dimension of the finger hole, or cutout) is segmented (cut, slit) to form a number (such as 6) of segments (labeled “a”-“f”), resulting in a “segmented” finger opening. If the access panel is plastic, these segments may deflect when the user inserts a finger into the opening, forming a somewhat airtight seal. The user should wear gloves to protect their fingers.

Alternatively, rather than having the segmented finger openings, two “finger gloves” (or finger cots) 132 may be provided, extending from the finger cutouts in the access panel to within the interior of the bag 100. The finger cots are not visible in FIG. 3. One finger cot 132 is illustrated in the side, cross-sectional view of FIG. 4.

A finger cot (also finger frock or finger stall, informally finger condom) is a medical device used to cover one or more fingers in situations where a full glove seems unnecessary. Like medical and rubber gloves, finger cots may be made from a variety of water-tight materials including latex, nitrile rubber, and vinyl.

The two finger cots 132 may be mounted to the access panel at the positions of the respective two finger holes 130 in any suitable manner, such as by gluing, taking care that the airtight integrity of the bag may be maintained.

The finger cots may be representative of any suitable means for allowing a user to insert at least two fingers into the bag, while maintaining a semblance of air-tightness, such as the somewhat undersized, flexible openings described above. Finger cots tend to be very tight, and a somewhat looser fit may be desirable, such as using something more akin to a condom.

In use, a user may insert two fingers (of one hand) through the finger openings, into the finger cots, and (with the other hand) place the item (small object) to be sandblasted through the opening in the “top” end of the bag into the bag, grasping the item (small object) to be sandblasted with the two fingers inserted in the finger cots. The user would then close (seal) the bag opening, using the slider (and the other hand), and commence sandblasting.

Sandblasting may be performed with a self-contained disposable micro-abrasive blasting tip for dental applications, such as described in the aforementioned U.S. Pat. No. 7,607,972 (27 Oct. 2009; Groman), incorporated by reference herein. Said blasting tip (or “sandblaster” or “sandblasting tool”) generally comprises:
a micro-abrasive blasting device (75) constructed from a disposable pipette structure (80) comprising a delivery conduit (30) extending from a delivery conduit inlet (35) through a tapered section (33) to form a delivery conduit outlet (37) and a inlet port (27); contiguous pipette structure (80) expands from inlet port (27) to form a hollow bulb mixing chamber (23) and then narrows to form a discharge port (29) section; a discharge conduit (10) is in fluid communications with discharge port (29) and extends from a discharge conduit inlet (12) internal to mixing chamber (23) to a discharge conduit outlet (14) external to mixing chamber (23); a particulate matter (50) is disposed within mixing chamber wall (25); discharge conduit inlet (12) abuts inlet port (27) preventing particulate matter (50) from exiting mixing chamber 23. A separation gap (45) between the delivery conduit outlet (37) and discharge conduit inlet (12) is created as discharge conduit (10) is displaced so discharge conduit inlet (12) no longer abuts inlet port (27); As pressurized-gas is supplied to micro-abrasive blasting device (75) through the delivery conduit inlet (35), the pressurized-gas flows through the delivery conduit (30) and out of the inlet port (27), into mixing chamber (23). As flow is initiated, particulate matter (50) instantaneously mixes with the gas-steam within hollow resilient bulb mixing chamber (23) and the powder-gas mixture flows through discharge conduit (10) to strike target surface (40). [Abstract]

Generally, when the tip (discharge outlet) of the sandblasting device is inserted into the bag, such as by piercing the front or back panels thereof, the subsequent airflow will tend to keep the bag inflated. Air can escape through the filter, while detritus is retained within the bag.

A “system” for performing micro-abrasive blasting for dental applications may comprise the Disposable Dust Cabinet (i.e., bag, access panel, etc.) disclosed herein, and a micro-abrasive blasting tip for dental applications such as disclosed in U.S. Pat. No. 7,607,972.

Sandblasting may be performed in the following manner. The user may simply
(with one hand) poke a hole in one of the front or back panels of the bag with the sandblaster nozzle (discharge conduit outlet 14 of U.S. Pat. No. 7,607,972), maintaining a grip on the sandblaster (micro-abrasive blasting tip of U.S. Pat. No. 7,607,972); and
(with the other hand) hold (grasp) the object to be sandblasted with the fingers in the finger cot.
then, with the air turned on, and the sandblaster blasting, the user can manipulate both the sandblaster (with the one hand) and the object being sandblasted (with the other hand) to effect the desired sandblasting (surface treatment) of the small object (dental device).

At the conclusion of sandblasting, the user may:
withdraw the nozzle of the sandblasting apparatus from the bag, and set aside the sandblasting apparatus;
open the bag;
with the now free hand which had been holding the sandblasting apparatus, retrieve the object from the bag; and
withdrawing the two fingers of the other hand from the finger cots.

The access panel 120 may also be provided with an air filter 140 so that pressurized air may escape from the bag, without allowing detritus (waste material of sandblasting) to escape. More particularly, the filter provides sufficient air flow so that the bag does not burst during operation.

The filter 140 may be glued over (or under) an opening in the access panel 120. For simplicity, it is shown in FIG. 4 as being disposed in the opening, somewhat flush with the access panel, and extending into the underlying opening in the access panel. However it may be mounted, the filter communicates air from within the bag to outside of the bag. In an integral plastic construction, the filter may comprise a plurality of small holes in the plastic material of the access panel.

FIG. 4A is partial cross-sectional view of the access panel 120, with a filter 140 disposed on its external surface, spanning a hole 142 in the access panel.

FIG. 4B is partial cross-sectional view of the access panel 120, with a filter 140 disposed on its internal surface, spanning a hole 142 in the access panel.

A simple flap valve may accomplish the same goal (preventing bag bursting), but would not filter detritus from the escaping air. A filter is preferred. The filter may be located separate from the access panel, on other than front panel of the bag (i.e., independent of the access panel and finger cutouts).

In use, when airflow is applied (via the sandblasting tool), the bag may inflate, and the filter prevents powder from escaping the cabinet. As mentioned above, bag material in the inside of the glue periphery of the access panel is removed, and this allows air to flow through the filter, and the user's fingers can protrude into the bag.

The filter is intended to absorb detritus (powder, etc.) from the use of at least one disposable sandblaster (such as in the aforementioned U.S. Pat. No. 7,607,972) prior to it becoming clogged, restricting its flow out of the bag while allowing filtered air to escape. Nevertheless, the user may wish to wear a filter mask while performing the sandblasting operation. The disposable dental cabinet 100 is intended to be used only once, then discarded.

It is within the scope of the invention that a “bespoke” bag may be fabricated, with finger cots formed integrally therein, and with a filter integrated into the bag.

As mentioned above, the finger openings may be formed as segments (FIG. 3A) in the plastic material of the access panel. This would eliminate the need for separate finger cots to be joined with the access panel. Another “solution” may be to form small finger openings which are resilient so that when a user inserts their finger(s) (preferably wearing a glove) into the opening, the opening itself seals around the finger(s). To prevent tearing, a periphery of such undersize holes may be reinforced, such as by increasing the thickness around the perimeter. This may be best suited to an “all plastic” solution, such as described herein (the access panel is an area of increased thickness in the plastic front or back panel of the bag). As further mentioned above, the filter may be formed as a plurality of small holes in the plastic material of the access panel. This would eliminate the need for a separate filter to be joined with the access panel. The access panel itself may simply be a designated area of the bag which may be stiffer than the remainder of the front and back panels of the bag, and perhaps of greater thickness than the remainder of the bag, which may be accomplished by laminating an additional ply (such as of plastic) to the “access panel area” of the bag. By combining these features, the entire apparatus may be formed with fewer parts, involving fewer steps, and resulting in an object having only one material (e.g., plastic) which would readily be recyclable.

### APPENDIX 1 (CUP EMBODIMENT, FIGS. 1,2)

An Appendix with photographs is provided herewith, and forms part of the disclosure hereof. This shows a process flow for using the cup embodiment. 3 pages.

### APPENDIX 2 (BAG EMBODIMENT, FIGS. 3,4)

An Appendix with photographs is provided herewith, and forms part of the disclosure hereof. This shows some construction details of the bag embodiment. 2 pages.

Top Left Photograph

White Cardboard with three cutouts

Cardboard is glued to ziplock bag close to zipper so zipper is supported.

One cutout for filter material is sized so the filter is able to:

1. Provide sufficient airflow so bag does not burst during operation

2. absorb powder from one disposable sandblaster operation prior to restriction of flow causing the bag to burst.

Bottom Left Photograph

Two cutout are sized so fingers can access them and spaced apart so the cardboard is comfortably rested and supported by both fingers.

ZipLock Bag is positioned so when ziplock is open the slider is in the upper portion of cardboard.

Top Right Photograph

Filter is glued to cardboard

‘finger gloves’ or ‘condoms’ or rubber-y membranes are glued at each finger cutout hole

bag is glued to cardboard on the periphery Bag material on the inside of the glue periphery is removed so air can flow thru filter and fingers can protrude into the bag.

Bottom Right Photograph

User places fingers through holes into the rubber membranes (finger cots) and places the item to be sandblasted in the fingers thru the opening in the ziplock bag.

User ziplocks the bag to close the cabinet then pokes a hole in the bag with the sandblaster nozzle. When air flow is applied the bag inflates and the filter prevents powder from escaping the cabinet.

### SOME ADDITIONAL COMMENTS

In some cases, only one finger hole may be needed. For example, when a small orthodontic bracket needs to be held by a clamping tweezers-type tool (such as forceps). In this case, the user would, insert the tool into the finger hole and place the bracket in the tool so the rubber cot is a membrane between them, such as one of the finger holes described hereinabove.

Of course, such a procedure using a tool, which may require only one hole, could be done by using only one of the two finger holes (and cots) in the “standard” bag, such as described hereinabove.

APPENDIX 3 shows a bag, open (unzipped) at the end, with a tool inserted into a finger cot (or the like). The tool is shown holding a dental bracket (with the cot/membrane therebetween) within the bag, for treatment (such as sandblasting).

In some applications, which are not sandblasting, a rotary tool (like a Dremel™) is utilized to mill dental devices for cleaning and shaping. In these cases, 2 finger holes may be required. Since there is no airflow, (1) the filter is not needed, and (2) the bag will not stay inflated. In order to keep the bag open (not collapsed upon itself), an additional component such as a cardboard flap, or wire hoop may be provided to fit within the bag and keep it “stretched” during use. The bag will still function as a “shield”, keeping most of the detritus contained within the bag.

While the invention(s) has/have been described with respect to a limited number of embodiments, these should not be construed as limitations on the scope of the invention(s), but rather as examples of some of the embodiments. Those skilled in the art may envision other possible variations, modifications, and implementations that are also within the scope of the invention(s), based on the disclosure(s) set forth herein.

1. Disposable dust cabinet apparatus for sandblasting small items, comprising:
a bag having a front panel and a back panel, wherein one end of the bag is open and has means for selectively sealing and opening the bag;
an access panel disposed on a one of the front and rear panels; and
at least one finger cutout extending through the access panel for allowing a user to insert corresponding at least one of their fingers into the bag, through the access panel.

2. The apparatus of claim 1, wherein:
there are two finger cutouts extending through the access panel for allowing a user to insert corresponding two of their fingers into the bag, through the access panel.

3. The apparatus of claim 1, wherein:
material of the access panel, outside of the cutout, is segmented to have a number of segments.

4. The apparatus of claim 1, further comprising:
at least one finger cot extending from the corresponding at least one finger cutout in the access panel to within an interior of the bag.

5. The apparatus of claim 1, wherein:
the front and back panels are generally rectangular in shape, and are substantially the same size as one another.

6. The apparatus of claim 1, wherein:
the access panel is formed of a flexible semi-rigid material selected from the group consisting of card stock and plastic.

7. The apparatus of claim 1, wherein the means for selectively sealing and opening the bag comprises:
one or more rows of grooves provided along an edge of one of the front and back panels, and one or more rows of ridges provided along an edge of another of the front and back panels.

8. The apparatus of claim 7 further comprising:
a slider for selectively engaging the ridges into the grooves, thereby sealing the bag, and disengaging the ridges from the grooves, thereby opening the bag.

9. The apparatus of claim 1, further comprising:
an air filter disposed on one of the front and back panels of the bag.

10. The apparatus of claim 1, wherein:
the air filter is disposed on the access panel.

11. The apparatus of claim 1, wherein:
the access panel comprises a designated area of the bag which is stiffer than the front and back panels of the bag.

12. System for performing micro-abrasive blasting for dental applications, comprising:
the disposable dust cabinet apparatus as set forth in claim 1; and
a micro-abrasive blasting tip for dental applications.

13. The system of claim 12, wherein the micro-abrasive blasting tip for dental applications is the micro-abrasive blasting tip disclosed in U.S. Pat. No. 7,607,972.

14. Method of sandblasting a small object, comprising:
providing a disposable dust cabinet apparatus as set forth in claim 1;
with one hand, inserting two fingers into corresponding two finger cots;
with the other hand, placing the small object into the bag, via the open end of the bag;
with the two fingers of the one hand, grasping the object to be sandblasted;
with the other hand, closing the open end of the bag;
introducing a nozzle of a sandblasting apparatus into the bag; and
performing the sand blasting.

15. The method of claim 14, further comprising:
while performing the sandblasting, manipulating both the sandblasting apparatus and the object being sandblasted.

16. The method of claim 14, further comprising, at the conclusion of sandblasting:
withdrawing the nozzle of the sandblasting apparatus from the bag;
opening the bag;
with the other hand, retrieving the object from the bag; and
withdrawing the two fingers of the one hand from the finger cots.

17. The method of claim 14, wherein:
the small object is a dental device; and
the sandblasting apparatus comprises a micro-abrasive blasting tip for dental applications.
